(19) United States
(12) Patent Application Publication
(10) Pub. No.: US 2006/0029741 A1
(43) Pub. Date: Feb. 9, 2006

(54) Magnetic particle-coated material, magnetic recording medium, electromagnetic shield material, and methods of manufacturing same

(75) Inventors: Yasushi Hattori, Kanagawa (JP); Koukichi Waki, Kanagawa (JP); Toshio Ishida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/248,411

(22) Filed: Oct. 13, 2005

Related U.S. Application Data
(62) Division of application No. 10/687,961, filed on Oct. 20, 2003.

(30) Foreign Application Priority Data
Oct. 21, 2002 (JP) 2002-305555
Jul. 31, 2003 (JP) 2003-283804

(51) Int. Cl. B05D 5/12; B05D 3/02; G11B 5/65

(52) U.S. Cl. 427/383.1; 428/836.1; 427/128

(57) ABSTRACT

The present invention provides a magnetic particle-coated material having a layer including a CuAu type or Cu₃Au type ferromagnetic ordered alloy phase on an organic support. Further, the present invention provides a method of manufacturing a magnetic particle-coated material that sequentially includes a step of manufacturing alloy particles capable of forming a ferromagnetic ordered alloy phase, a step of coating an organic support with the alloy particles to form a coating film, and a step of annealing the coating film in a reducing atmosphere to make the alloy particles into magnetic particles, and further includes a step of oxidizing the alloy particles, the oxidizing step being performed between the alloy particle manufacturing step and the annealing step.

### CROSS-REFERENCE TO RELATED APPLICATIONS

This application is a divisional application of U.S. application Ser. No. 10/687,961 filed Oct. 20, 2003, which claims benefit of and priority to Japanese Patent Applications Nos. 2002-305555, filed on Oct. 21, 2002, and 2003-283804, filed on Jul. 31, 2003, which are incorporated herein by reference in their entireties for all purposes.

### BACKGROUND OF THE INVENTION

1. Field of the Invention

The present invention relates to a magnetic particle-coated material, a magnetic recording medium, an electromagnetic shield material and methods of manufacturing same.

2. Description of the Related Art

In the field of magnetic recording using the magnetic particle-coated materials, reducing the diameter of particles is necessary to increase magnetic recording density. For example, in magnetic recording media, which are widely used as videotapes, computer tapes and disks, when the weight of the ferromagnetic material is the same noise decreases as the particle diameter decreases. A CuAu type or Cu₃Au type ferromagnetic ordered alloy has a large crystalline magnetic anisotropy because of strain caused at the time of ordering and displays, ferromagnetism even when the particle diameter is reduced, and hence is a promising raw material for the improvement of magnetic recording density.

On the other hand, magnetic recording media are required to not only increase magnetic recording density but also at the same time to be inexpensive. However, the alloy composition for forming a CuAu type or Cu₃Au type ferromagnetic ordered alloy contains noble metals and hence the resulting magnetic material becomes expensive, thus failing to satisfy the above requirements.

Therefore, consideration is being to the use of an inexpensive organic support. However, nanoparticles which are synthesized by a liquid phase method or a by vapor phase method (which, in particular, means alloy particles of a CuAu type or Cu₃Au type ferromagnetic ordered alloy) have a disordered phase, and, in order to produce an ordered phase displaying ferromagnetism, it is necessary to conduct an annealing treatment at 500° C. or more. Therefore, in cases when an organic support of low heat resistance is used, it is difficult to anneal at the high temperature described above.

In view of the above facts, a method is disclosed wherein only nanoparticles are annealed and the nanoparticles are applied to an organic support together with a binder (for example, in Japanese Patent Application Laid-Open (JP-A) No. 2002-157727). However, in a process where only the nanoparticles are annealed according to this method, the particles sometimes fuse and adhere to each other. Thus, for practical purposes, this method is undesirable.

Incidentally, in a recent communication environment where communication equipment is used in close proximity to such equipment, increasing the frequency of communication equipment can on occasions cause a deterioration in the quality of communications. Thus, in order to prevent degradation in the quality of communications as a result of absorbing unnecessary radio waves from the communication equipment, magnetic materials displaying higher magnetic permeability in a high frequency range are used as the constituent components of the communication equipment.

Such radio wave absorbing materials used for communication equipment are required to have the following characteristics to realize high magnetic permeability in the high frequency range. That is, magnetic materials constituting the radio wave absorbing materials are required to display simultaneously high electric resistance and high saturation magnetization, and to have a small anisotropic magnetic field and magnetostriction. A “nanogranular structure” has received widespread attention as a structure of a magnetic material displaying all the above characteristics at the same time.

Here, the magnetic material having the nanogranular structure is manufactured by first utilizing a method of manufacturing a magnetic thin film having a nanogranular structure and by repeating a process of sputtering. It is expected that a magnetic thin film up to about 100 μm in thickness can be formed by this method. However, this method not only needs a long time to manufacture but also absorbs high manufacturing costs. Therefore, in terms of productivity, this method is not necessarily effective.

### SUMMARY OF THE INVENTION

The present invention uses a CuAu type or Cu₃Au type ferromagnetic ordered alloy capable of achieving a high magnetic recording density (hereinafter, in some cases, simply referred to as “a ferromagnetic ordered alloy”) to provide an inexpensive magnetic particle-coated material.

Further, the invention provides a method of manufacturing a magnetic particle-coated material suitable for manufacturing the above-mentioned magnetic particle-coated material, a magnetic recording medium using the above-mentioned magnetic particle-coated material, and an electromagnetic shield material.

As a result of earnest study to solve the above problems, the inventors have discovered that the above problems can be solved by the invention described below. Namely, a first aspect of the present invention is to provide a magnetic particle-coated material including: a support including an organic-material; and a layer formed on the support and including a CuAu type or Cu₃Au type ferromagnetic ordered alloy phase.

A second aspect of the present invention is to provide a magnetic recording medium including: a support including an organic material; and a magnetic layer formed on the support, wherein the magnetic layer comprises a layer including a CuAu type or Cu₃Au type ferromagnetic ordered alloy phase.

Further, a third aspect of the present invention is to provide a electromagnetic shield material including a magnetic particle-coated material as a structural member, wherein the magnetic particle-coated material comprises a support including an organic material and a layer formed on the support and including a CuAu type or Cu₃Au type ferromagnetic ordered alloy phase.

According to the invention, even if a CuAu type or Cu₃Au type ferromagnetic ordered alloy capable of achieving a high magnetic recording density is used, it is possible to provide an inexpensive magnetic particle-coated material. Since the present magnetic particle-coated material uses an organic support, unlike a case using an inorganic support, cracks, chips or the like rarely occur. Further, it is possible to provide a method of manufacturing a magnetic particle-coated material suitable for manufacturing the above-mentioned magnetic particle-coated material and a magnetic recording medium for using the above-mentioned magnetic particle-coated material. Still further, it is possible to provide an electromagnetic shield material capable of absorbing electromagnetic waves, in particular, high-frequency electromagnetic waves.

### DETAILED DESCRIPTION OF THE INVENTION

Magnetic particle-coated material and Method of manufacturing the magnetic particle-coated material

[1] Magnetic Particle-Coated Material

The magnetic particle-coated material of the present invention has a layer containing a CuAu type or Cu₃Au type ferromagnetic ordered alloy phase on an organic support.

Moreover, the magnetic particle-coated material of the invention is a magnetic particle-coated material manufactured especially by conducting, sequentially, step of manufacturing alloy particles capable of forming a CuAu type or Cu₃Au type ferromagnetic ordered alloy phase, a step of coating an organic support with the alloy particles to form a coating film and a step of annealing the coating film under a reducing atmosphere to make the alloy particles into magnetic particles, and conducting a step of oxidizing the alloy particles, which step is performed between the alloy particle manufacturing step and the annealing step.

The magnetic particle-coated material of the invention is inexpensive due to the use of the organic support and also capable of improving magnetic characteristics and electromagnetic wave absorbing characteristics when applied to magnetic recording media or electromagnetic shield materials such as those described hereinafter.

In this regard, in this specification, “the magnetic particle-coated material” means a laminate including at least a support and a layer or coating film containing the above-mentioned CuAu type or Cu₃Au type ferromagnetic ordered alloy phase formed on the support.

[2] Method of Manufacturing the Magnetic Particle-Coated Material

A method of manufacturing the magnetic particle-coated material of the invention sequentially includes (i) a step of manufacturing alloy particles capable of forming a CuAu type or Cu₃Au type ferromagnetic ordered alloy phase, (ii) a step of coating an organic support with the alloy particles to form a coating film and (iii) a step of annealing the coating film under a reducing atmosphere to make the alloy particles into magnetic particles, and also includes (iv) a step of oxidizing the alloy particles before the annealing step (iii).

Hereinafter, while describing the above-mentioned respective steps, the method of manufacturing the magnetic particle-coated material and the magnetic particle-coated material will be described.

(1) Alloy Particle Manufacturing Step

Alloy particles to be made into magnetic particles by annealing treatment can be manufactured by a vapor phase method or by a liquid phase method. The liquid phase method is preferable because it is most appropriate for mass production. Various conventional liquid phase methods can be used as the liquid phase method and it is preferable to use a reduction method established by improving those methods. Among reduction methods, a reverse micelle method by which particle diameter can be easily controlled is especially preferable.

Reverse Micelle Method

The above-mentioned reverse micelle method includes at least (1) a reducing step of mixing two kinds of reverse micelle solutions to perform a reducing reaction and (2) a step of aging at a predetermined temperature after the reducing reaction.

The respective steps will be described as follows.

(1) Reducing Step

First, a surfactant-containing water-insoluble organic solvent and an aqueous solution of a reducing agent are mixed to prepare a reverse micelle solution (I).

An oil-soluble surfactant is used as the surfactant. More specifically, the oil-soluble surfactant includes a sulfonate type surfactant (for example, trade name: Aerosol OT, manufactured by Wako Pure Chemical Industries, Ltd.), a quaternary ammonium salt type (for example, cetyltrimethylammonium bromide), and an ether type (for example, pentaethylene glycol dodecyl ether).

The amount of surfactant in the water-insoluble organic solvent preferably ranges from 20 g/l to 200 g/l.

A preferable water-insoluble organic solvent for dissolving the above-mentioned surfactant includes alkanes, ethers, alcohols and the like.

Alkanes containing from 7 to 12 carbon atoms are preferable as the alkane. More specifically, heptane, octane, isooctane, nonane, decane, undecane, dodecane and the like are preferably used as the alkane.

Diethyl ether, dipropyl ether, dibutyl ether and the like are preferable as the ether.

Ethoxyethanol, ethoxypropanol and the like are preferable as the alcohol.

It is preferable to use alcohols; polyalcohols; H₂; and compounds containing HCHO, S₂O₆²⁻, H₂PO²⁻, BH₄⁻, N₂H⁻, or H₂PO₃⁻ or the like alone or in combination as the reducing agent in the aqueous reducing agent solution.

Preferably, the amount of the reducing agent in the aqueous solution ranges from 3 mol to 50 mol based on 1 mol of a metal salt.

Here, it is preferable that a mass ratio of water to the surfactant (water/surfactant) in the reverse micelle solution (I) is not more than 20. If the mass ratio is more than 20, a problem arises that precipitation tends to occur easily and that particles are apt to become irregular in diameter. The mass ratio is preferably not larger than 15, more preferably, from 0.5 to 10.

Besides the above-mentioned reverse micelle solution (I), a surfactant-containing water-insoluble organic solvent and an aqueous metal salt solution are mixed to prepare a reverse micelle solution (II).

The conditions of the surfactant and the water-insoluble organic solvent (substances to be used, their concentration and the like) are the same as those for the reverse micelle solution (I).

In this regard, substances (surfactant and water-insoluble organic solvent) of either the same kind or a different kind to those used in the reverse micelle solution (I) can be used for the reverse micelle solution (II). Moreover, the mass ratio of water to the surfactant in the reverse micelle solution (II) is in the same range as that of the reverse micelle solution (I), and may be equal to or different from the mass ratio in the reverse micelle solution (I).

It is preferable that the metal salt contained in the aqueous metal salt solution is suitably selected so that the magnetic particles to be manufactured can form a CuAu type or Cu₃Au type ferromagnetic ordered alloy.

Here, the CuAu type ferromagnetic ordered alloy includes alloys such as FeNi, FePd, FePt, CoPt and CoAu, and among these alloys, FePd, FePt and CoPt are preferable.

The Cu₃Au type ferromagnetic ordered alloy includes Ni₃Fe, FePd₃, Fe₃Pt, FePt₃, CoPt₃, Ni₃Pt, CrPt₃ and Ni₃Mn, and among these alloys, FePd₃, FePt₃, CoPt₃, Fe₃Pd, Fe₃Pt and CO₃Pt are preferable.

Specific examples of the metal salt include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, Co(OCOCH₃)₂ and the like.

The concentration of the aqueous metal salt solution (as the concentration of the metal salt) is preferably from 0.1 μmol/ml to 1000 μmol/ml and more preferably, from 1 μmol/ml to 1000 μmol/ml.

By suitably selecting the metal salt, alloy particles, that are capable of forming the CuAu type or Cu₃Au type ferromagnetic ordered alloy in which a noble metal is alloyed with a base metal, are produced.

As for the alloy particles, their alloy phase needs to be transformed from an disordered phase to an ordered phase by means of an annealing treatment described below and in order to lower a transformation temperature, it is also preferable that a third element such as Sb, Pb, Bi, Cu, Ag, Zn and In is added to the above-mentioned binary alloy. As for this third element, it is preferable that a precursor of each third element is added to the above-mentioned metal salt solution. The amount of the third element added to the binary alloy is preferably from 1 at % to 30 at %, and more preferably from 5 at % to 20 at %.

The reverse micelle solutions (I) and (II) prepared in the above manner are mixed. Though the mixing method is not specifically limited, in consideration of the need for uniformity in a reducing reaction, it is preferable to add the reverse micelle solution (II) while agitating the reverse micelle solution (I). After the mixing is completed, a reducing reaction is undertaken and the temperature is preferably set at a constant temperature within a range from −5° C. to 30° C.

If the reducing temperature is lower than −5° C., a problem occurs that the water phase condenses to make the reducing reaction irregular, and if the reducing temperature is higher than 30° C., aggregation or precipitation is apt to occur, which may make the system unstable. The reducing temperature preferably ranges from 0° C. to 25° C., and more preferably from 5° C. to 25° C.

Here, the above-mentioned “constant temperature” means that when the set temperature is represented as T° C., T can fluctuate within T±3° C. Here, even in this case, the upper limit and the lower limit of T should be considered to be within the range of the above-mentioned reducing temperature range (from −5° C. to 30° C.).

The time for the reducing reaction needs to be suitably set according to factors such as the amount of the reverse micelle solution and is preferably set at from 1 min to 30 min, and more preferably from 5 min to 20 min.

Because the reducing reaction has a large influence on the monodispersity of particle diameter distribution, it is preferable that the reducing reaction is undertaken with the agitating process taking place at a speed as high as possible.

A preferable agitator is an agitator having a high shearing force and in more detail, an agitator of the type rotating its agitating wings by a motor in which the wings basically have a turbine type- or paddle type-structure and an agitator which further has a structure having sharp blades at the edges of wings or at positions where the blades are put into contact with the wings. To be more specific, equipment such as Dissolver (trade name, manufactured by Tokushu Kika Kogyo Co., Ltd.), Omnimixer (trade name, manufactured by Yamato Scientific Co., Ltd.), and Homogenizer (trade name, manufactured by SMT Co., Ltd.) are useful. By using this kind of apparatus, it is possible to synthesize monodispersed alloy particles in the form of a stable dispersion.

It is also preferable that at least one kind of dispersing agent having one to three amino groups or carboxyl groups is added to at least one of the reverse micelle solutions (I) and (II) by from 0.001 mol to 10 mol per 1 mol of the alloy particles to be manufactured.

By adding such dispersing agents, it is possible to produce alloy particles of excellent monodispersity and free from aggregation.

If the amount of dispersing agent added is smaller than 0.001 mol, there are cases where the monodispersity of the alloy particles can not be improved, and if the amount of dispersing agent added is larger than 10 mol, there are cases where aggregation will occur.

Organic compounds having groups capable of being adsorbed to the surface of the alloy particles are preferable as the dispersing agent. Specific examples are organic compounds containing one to three amino groups, carboxyl groups, sulfonic acid groups, or sulfinic acid groups and which can be used alone or in combination.

These compounds are expressed by structural formulae of R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂H—R—SO₂H and SO₂H—R(SO₂H)—SO₂H, wherein R in the formulae denotes straight-chain, branched-chain or cyclic saturated or unsaturated hydrocarbons.

An especially preferable compound as the dispersing agent is oleic acid. Oleic acid is a well known surfactant for stabilizing colloid and has been used to protect metal particles such as iron. Oleic acids has a comparatively long chain (for example, oleic acid has a chain of 18 carbons whose length is up to 20 angstroms (=up to 2 nm). Oleic acid, which is not a saturated aliphatic compound and has one double bond, causes, an important steric hindrance that overcomes strong magnetic interaction between the particles.

A similar long-chain carboxyl acid such as erucic acid or linolic acid is also used as the dispersing agent in the same manner as oleic acid (for example, a long-chain organic acid having 8 to 22 carbon atoms can be used either alone or in a combination of a plurality of kinds thereof). Oleic acid (such as olive oil) is preferable because it is an inexpensive natural resource which is easily available. Moreover, oleylamine induced from oleic acid is also a useful dispersing agent in just the same way as oleic acid.

In the above-mentioned reducing step, it is thought that metals which are base in oxidation-reduction potential (metals not greater than about −0.2 V (vs. N.H.E)) such as Co, Fe, Ni and Cr in the CuAu type or Cu₃Au type ferromagnetic ordered alloy phase are reduced to cause deposition in the monodispersed state with an extremely small size. Then, during a temperature increasing step and an aging step, which will later be described, the deposited base metals thereafter become nuclei and noble metals which are noble in the oxidation-reduction potential such as Pt, Pd and Rh (metals not less than about −0.2 V (N.H.E)) are reduced by the base metals and thereby substituted and deposited on the surfaces of the nuclei of the base metals. It is thought that the ionized base metals are reduced again by the reducing agent and thereby deposited. By such repetition, alloy particles, which are capable of forming the CuAu type or Cu₃Au type ferromagnetic ordered alloy, are provided.

(2) Aging Step

After the reducing reaction is completed, the temperature of the solution after the reaction is increased to an aging temperature.

It is preferable that the aging temperature is set at a constant temperature from 30° C. to 90° C. and that the aging temperature is made higher than the temperature of the reducing reaction. Also, it is desirable that an aging time is from 5 min to 180 min. If the aging temperature and the aging time exceed the above ranges, aggregation or precipitation is apt to occur, whereas if they are less than the above ranges, cases occur where the reducing reaction is not completed, and accordingly the composition is changed. Preferable aging temperature and time range are from 40° C. to 80° C. and from 10 min to 150 min, and more preferable aging temperature and time range are from 40° C. to 70° C. and from 20 min to 120 min.

Here, the above-mentioned “constant temperature” has the same definition as the temperature of the reducing reaction (provided in this case that “reducing temperature is replaced by “aging temperature”), and in particular, it is preferable that the aging temperature be higher than the temperature of the reducing reaction by 5° C. or more within the range of the aging temperature (from 30° C. to 90° C.), and more preferably by 10C or more. If the temperature difference is smaller than 5° C., cases occur where the prescribed composition can not be provided.

In the aging step described above, the noble metals are deposited on the base metals reduced and deposited in the reducing step.

That is, the noble metals are reduced only on the base metals, so there is never a case where the base metals and the noble metals are separately deposited. Thus, it is possible to manufacture efficiently alloy particles capable of forming the CuAu type or Cu₃Au type ferromagnetic ordered alloy in accordance with the prescribed composition at a high yield, and thus to control the alloy particles to a desired composition. Moreover, by suitably controlling the agitating speed at the aging temperature, it is possible to make the alloy particles have a desired particle size.

After the aging step is completed, it is preferable to provide a washing/dispersing step wherein the above-mentioned solution after aging is washed with a mixed solution of water and a primary alcohol, and then precipitate generated by precipitating treatment using a primary alcohol is dispersed by an organic solvent.

By providing such a washing/dispersing step, it is possible to remove impurities and to further improve ease of coating at the time that the magnetic layer of magnetic recording media is formed by coating.

The above-mentioned washing step and dispersing step are respectively performed at least once and more preferably, at least twice.

The primary alcohol used for the washing step is not specifically limited, but primary alcohol such as methanol or ethanol is preferably used. A volume mixing ratio (water/primary alcohol) preferably ranges from 10/1 to 2/1 and more preferably, from 5/1 to 3/1. If the ratio of water is higher, the surfactant may on occasions be hard to remove, whereas if the ratio of the primary alcohol is higher, aggregation may occur.

In the manner described above, alloy particles dispersed in a solution (namely, an alloy particle-containing solution) are provided. Since the alloy particles are monodispersed, even if they are applied to the support, they can retain their uniformly dispersed state without aggregation. Thus, even if they are subjected to annealing treatment, the respective alloy particles do not aggregate, and efficient ferromagnetization becomes possible, leading to excellent coating suitability.

From the viewpoint of reducing noise, it is preferable that the diameter of the alloy particles before the oxidizing treatment, which will later be described, is small, but if the diameter is too small, the particles become super-paramagnetic after annealing and thus on occasions may be unsuitable for magnetic recording. In general, the diameter preferably ranges from 1 nm to 100 nm, and more preferably, from 1 nm to 20 nm, and still more preferably from 3 nm to 10 nm.

Reducing Method

There are various other reducing methods for manufacturing alloy particles capable of forming the CuAu type or Cu₃Au type ferromagnetic ordered alloy. However, it is preferable to adopt a method of reducing at least a metal whose oxidation-reduction potential is base (in some cases, hereinafter simply referred to as “base metal”) and a metal whose oxidation-reduction potential is noble (in some cases, hereinafter simply referred to as “noble metal”) in an organic solvent, water, or a mixed solution of an organic solvent and water by the use of a reducing agent or the like.

The order of reducing the base metal and the noble metal is not specifically limited and they can be reduced at the same time.

An alcohol, polyalcohol and the like can be used as the above-mentioned organic solvent, including alcohol such as methanol, ethanol and butanol, and the polyalcohol includes such as ethylene glycol and glycerin.

Incidentally, examples of the CuAu type or Cu₃Au type ferromagnetic ordered alloy are the same as described in the case of the above-mentioned reverse micelle method.

Moreover, a method such as that disclosed from the 18^{th} to 30^{th} paragraph of Japanese Patent Application No. 2001-269255 can be applied as a method in which a noble metal is deposited in advance to prepare the alloy particles.

Pt, Pd, Rh and the like can preferably be used as the metal whose oxidation-reduction potential is noble, and H₂PtCl₆ 6H₂O, Pt(CH₃COCHCOCH₃)₂, RhCl₃.3H₂O, Pd(OCOCH₃)₂, PdCl₂ and Pd(CH₃COCHCOCH₃)₂ and the like can be used for dissolving into a solvent. The concentration of the metal in the solution preferably ranges from 0.1 μmol/ml to 1000 μmol/ml, and more preferably from 0.1 μmol/ml to 100 μmol/ml.

Further, Co, Fe, Ni and Cr can preferably be used as the metal whose oxidation-reduction potential is base, and Fe and Co can be especially preferably used. FeSO₄.7H₂O, NiSO₄.7H₂O, CoCl₂.6H₂O, Co(OCOCH₃)₂.4H₂O and the like can be used for dissolving into a solvent. The concentration of the metal in the solution preferably ranges from 0.1 μmol/ml to 1000 μmol/ml, and more preferably from 0.1 μmol/ml to 100 μmol/ml.

Still further, as in the case of the above-mentioned reverse micelle method, it is preferable that a third element is added to the binary alloy to reduce the temperature of transformation of the alloy to a ferromagnetic ordered alloy. The amount of the third element added is the same as that for the reverse micelle method.

For example, in a case where a base metal and a noble metal are reduced and deposited in that order by the use of a reducing agent, it is preferable to add to a noble metal source the reduced metal obtained by reducing the base metal or by reducing the base metal and a part of the noble metal with a reducing agent having a reduction potential more base than −0.2 V (vs. N.H.E), then to reduce the resultant metal by a reducing agent whose oxidation-reduction potential is more noble than −0.2 V (vs. N.H.E) and thereafter to reduce the reduced metal with a reducing agent having a reduction potential more noble than −0.2 V (vs. N.H.E).

Although the oxidation-reduction potential depends on the pH of a system, alcohols such as 1,2-hexadecanediol, glycerin, H₂ and HCHO can be preferably used as the reducing agent whose oxidation-reduction potential is more noble than −0.2 V (vs. N.H.E).

Preferably, S₂O₆²⁻, H₂PO₂⁻, BH₄⁻, N₂H₅⁻, and H₂PO₃⁻ can be used as the reducing agent having a reduction potential more base than −0.2 V (vs. N.H.E).

Here, in a case where a metal compound having 0 valence such as a Fe carbonyl is used as the raw material of the base metal, a reducing agent for the base metal is not required.

The presence of an adsorbent at the time when the noble metal is reduced and deposited can stabilize and prepare the alloy particles. It is preferable that a polymer or surfactant is used as the adsorbent.

The above-mentioned polymer includes polymers such as poly(vinyl alcohol) (PVA), poly(N-vinyl-2 pyrrolidone) (PVP) and gelatin. Among these, PVP is especially preferable.

Moreover, the molecular weight preferably ranges from 20,000 to 60,000, and more preferably from 30,000 to 50,000. The amount of a polymer preferably ranges from 0.1 to 10 times the mass of the alloy particles to be manufactured, and more preferably from 0.1 to 5 times.

It is desirable that a surfactant preferably used as the adsorbent contains an “organic stabilizer” which is a long-chain organic compound expressed by a general formula of R—X. R in the general formula is a “tail group” which is a linear or branched hydrocarbon or fluorocarbon chain and usually contains 8 to 22 carbon atoms. Moreover, X in the general formula is a “head group” which is a portion (X) to provide a specific chemical bond to the surface of the alloy particle. It is preferable that X is any one of sulfinate (—SOOH), sulfonate (—SO₂OH), phosphinate (—POOH), phosphonate (—OPO(OH)₂), carboxylate or thiol.

It is preferable that the organic stabilizer is any one of sulfonic acid (R—SO₂OH), sulfinic acid (R—SOOH), phosphinic acid (R₂POOH), phosphonic acid (R—OPO(OH)₂), carboxylic acid and thiol (R—SH) and the like. Among these, as in the case of the reverse micelle method, oleic acid is especially preferable.

A combination of the phosphine and the organic stabilizer, (triorganophosphine/acid and the like) can provide excellent controllability for the growth and stabilization of the particles. Didecyl ether and didodecyl ether can also be used but phenyl ether or n-octyl ether can preferably be used as a solvent due to their low cost and high boiling points.

It is preferable that the reaction proceeds within a temperature range from 80° C. to 360° C., depending on the alloy particles required and the boiling point of the solvent, and a temperature range from 80° C. to 240° C. is more preferable. If the temperature is lower than this range, the particles may not grow. If the temperature is higher than this temperature range, the particles may grow without being controlled and the generation of undesirable by-products may increase.

The diameter of the alloy particles is the same as for the reverse micelle method and preferably ranges from 1 nm to 100 nm, and more preferably, from 3 nm to 20 nm, and still more preferably, from 3 nm to 10 nm.

A seeding method is effective as a method of enlarging a particle size (particle diameter). In the case that the alloy particles are used as magnetic recording media, compressing the alloy particles is preferable to a maximum density for improving recording capacity. In order to achieve compressing to a maximum density, the standard deviation of the sizes of the alloy particles is preferably less than 10%, and more preferably less than 5%.

If the particle size is too small, the alloy particle becomes super-paramagnetic, which is not desirable. Thus, as described above, in order to enlarge the size of the particle, the seeding method can preferably be used. In these circumstances, cases may occur a case where a metal more noble than a metal constituting the particle is deposited. In such cases, the oxidation of the particle may be expected, and it is therefore preferable to hydrogenate the particle in advance.

From the viewpoint of preventing oxidation, it is preferable to form the outermost layer of the alloy particle from a noble metal, but in such cases the alloy particle is apt to aggregate. Thus, the outermost layer is preferably formed with an alloy of a noble metal and a base metal in the invention. Such a constitution can be realized with ease and efficiency by the already described liquid phase method.

Desalting the solution after synthesizing the alloy particles is preferable from the viewpoint of improving the dispersion stability of the alloy particles. Among methods of desalting the solution, there is a method wherein an alcohol is added to an excessive degree in order to generate slight aggregation, and then this aggregation is precipitated naturally or centrifugally so as to remove salts together with the supernatant. However, such a method tends to make alloy particles aggregate and therefore it is preferable to use an ultrafiltration method.

In this manner, alloy particles dispersed in the solution (alloy particle-containing solution) can be obtained.

A transmission electron microscope (TEM) can be used to evaluate the particle diameter of the alloy particles. In order to determine the crystal system of the alloy particle or magnetic particle, electron diffraction by the TEM can be used, but, X-ray diffraction is more preferably used because of its higher accuracy. It is preferable that the composition analysis of the interior of the alloy particle or magnetic particle is evaluated by means of a field emission transmission electron microscope (FE-TEM) capable of narrowing an electron beam together with an energy dispersive analysis of X-ray (EDAX). Further, the magnetic property of the alloy particle or magnetic particle can be evaluated by the use of a vibrating sample magnetometer (VSM).

(iv) Oxidizing Step

By oxidizing the manufactured alloy particles, magnetic particles having ferromagnetism can be efficiently manufactured without increasing the temperature at the time of annealing the alloy particles in a non-oxidizing atmosphere in a later step. This is thought to be caused by the following phenomenon: that is, first, by oxidizing the alloy particles, oxygen enters their crystal lattices; when the alloy particles are annealed in a state where oxygen has entered the crystal lattices; the oxygen is desorbed by heat from the crystal lattices; when the oxygen is desorbed, defects occur; these defects make metal atoms constituting the alloy move easily and hence phase transformation tends to occur more easily even in a comparatively low temperature.

Such a phenomenon is presumed by virture of measuring the EXAFS (extended X-ray absorption fine structure) of the alloy particles both after the oxidizing treatment and after the magnetic particles has been subjected to annealing treatment.

For example, in the Fe—Pt alloy particles not subjected to oxidizing treatment, the existence of bonds between a Fe atom and a Pt atom or between Fe atoms can be recognized.

In contrast, in the alloy particles subjected to oxidizing treatment, the existence of bonds between a Fe atom and an oxygen atom can be recognized. However, bonds between a Pt atom or Fe atom can hardly be recognized. This reveals that the bonds between Fe and Pt atoms and between Fe and Fe atoms have been cleaved by oxygen atoms. This is thought to suggest that Pt atoms and Fe atoms have become able to move easily during the course of the annealing treatment.

Then, after the alloy particles have been subjected to the annealing treatment, the existence of oxygen can not be recognized but the existence of bonds between a Pt atom and Fe atom can be recognized around Fe atoms.

It is clear from consideration of the above phenomenon that if the alloy particles are not oxidized, it becomes difficult for the phase transformation to proceed, thus creating a need for an increase in the annealing temperature. However, it is also thought that if the alloy particles are excessively oxidized, the interaction between easily oxidized metals such as Fe and oxygen becomes too strong, thereby causing metal oxide.

Thus, it is important to control the state of oxidization of the alloy particles and therefore to set conditions of oxidizing treatment which are the most appropriate.

For example, with regard to the oxidizing treatment, in a case where the alloy particles are manufactured by the above-mentioned liquid phase method and the like, it is essential only to supply the manufactured solution containing the alloy particles with gas containing at least oxygen (first oxidizing treatment).

An oxygen partial pressure at this time preferably ranges from 10% to 100%, and more preferably from 15% to 50% of the total pressure.

Moreover, an oxidizing treatment temperature preferably ranges from 0° C. to 100° C. and more preferably from 15° C. to 80° C.

In addition, it is preferable that after the organic support is coated with the alloy particles in a coating step which will be described later and before the alloy particles are subjected to an annealing treatment which will also be described later, the alloy particles be subjected to a second oxidizing treatment in which the alloy particles stand in an oxygen atmosphere or in air at a temperature from 0° C. to 80° C. for between 1 hour and 24 hours. This oxidizing treatment is a comparatively weak oxidizing treatment. By annealing the alloy particles in a reducing atmosphere to be described later, oxygen voids (holes) are formed and the phase transformation is accelerated.

It is preferable that the state of oxidation of the alloy particles is evaluated by measuring the EXAFS or the like. Then, from the view point of breaking by oxygen the bond between an Fe atom and an Fe atom and the bond between a Pt atom and an Fe atom, the number of bonds between a base metal such as Fe and oxygen preferably ranges from 0.5 to 4 and more preferably from 1 to 3.

(ii) Coating Step

If the alloy particles are subjected to annealing treatment in a state of particles, the alloy particles are apt to move and hence to fuse and adhere to each other. For this reason, the alloy particles provide a high magnetic coercive force but tend to have a drawback of becoming large in size. Thus, from the viewpoint of preventing the aggregation of the alloy particles, it is necessary that the alloy particles be applied on a substrate and made into a coating film before being subjected to the annealing treatment. If the alloy particles on the support are annealed to form magnetic particles, it is possible to provide a magnetic recording medium containing a layer (coating film) formed of such magnetic particles in a magnetic layer.

Here, an organic support is used as the above-mentioned support. Since the organic support is available at low cost as compared with an inorganic support such as metal, it can contribute to the highly productive manufacture of a magnetic recording medium.

In this regard, an organic support has in general terms a problem of heat resistance. However, in the invention, the alloy particles are subjected to the oxidizing treatment described above before they are subjected to the annealing treatment, so it becomes possible to conduct the annealing treatment at a temperature which does not present a problem for the heat resistance of the organic support. Thus, it becomes possible to manufacture a good magnetic particle-coated material and magnetic recording medium free from a warp and deterioration in quality.

A heat-resistant support is preferably used as the organic support and, to be more specific, a heat-resistant support such as an aramid, polyamide, polyimide, or polyamideimide can preferably be used.

When applying the alloy particles on the support, it is preferable that various kinds of additives be added as necessary depending on the alloy particle-containing solution after the oxidizing treatment has been completed.

At this time, it is preferable that the content of alloy particles in the alloy particle-containing solution be brought to a desired concentration (ranging from 0.01 mg/ml to 0.1 mg/ml).

Methods of coating the support include such methods as: air doctor coating; blade coating; rod coating; extrusion coating; air knife coating; squeeze coating; impregnation coating; reverse roll coating; transfer roll coating: gravure coating; kiss coating; cast coating; spray coating; and spin coating.

(iii) Annealing Step

An alloy particle subjected to the oxidizing treatment has a disordered phase. As described above, the disordered phase can not provide ferromagnetism. Thus, the alloy particles need to be subjected to heating treatment (annealing) in order to transform the disordered phase into an ordered phase. With regard to the annealing treatment, it is necessary to determine a transformation temperature at which the alloy constituting the alloy particles is transformed from the ordered phase to the disordered phase by the use of differential thermal analysis (DTA), and to anneal the alloy particles at a temperature higher than the determined transformation temperature.

The above-mentioned transformation temperature is usually about 500° C. but may be made lower by the addition of a third element. Thus, it is preferable that the annealing temperature be not lower than 150° C., and more preferably, from 150° C. to 500° C. As the third element, Ag, Cu, Pb, Bi, Sb and the like can be mentioned.

A reducing atmosphere such as methane, ethane and H₂ is used as an annealing treatment atmosphere from the viewpoint of desorbing by oxygenation oxygen existing on a lattice and thereby forming oxygen voids. It is preferable to control the orientation of a magnetic material by annealing the magnetic material in a magnetic field. From the viewpoint of preventing explosions, it is preferable to mix the reducing atmospheric gas with an inert gas such as N₂, Ar, He and Ne (the percentage of the reducing atmospheric gas preferably ranges from 1% to 5%).

In this case, it is difficult to achieve oxygen desorption, and it is thus necessary to adjust the annealing treatment time.

In order to prevent the alloy particles from fusing and adhering to each other during the annealing treatment, it is preferable that the alloy particles are annealed once in an inert gas at a temperature lower than the transformation temperature to carbonize the dispersing agent, and then annealed in the reducing atmosphere at a temperature higher than the transformation temperature.

Moreover, from the viewpoint of preventing the alloy particles from fusing and adhering to each other during the annealing treatment, it is preferable to add a binder such as a Si resin or PVP to a solution in which the alloy particles are dispersed, and to apply the solution and then to perform the annealing treatment.

Incidentally, a method of depositing a desired alloy on a support and thereby forming an alloy layer can be applied as a method of forming a layer (alloy layer) for forming a CuAu type or Cu₃Au type ferromagnetic ordered alloy phase which is later to be subjected to annealing treatment and thereby become a magnetic layer. The method is not limited to a specific method but a method of forming a film by sputtering is preferably used.

Methods of forming a film by sputtering include “a RF magnetron sputtering method (hereinafter, in some cases, referred to as “RF sputtering method”) and “a DC magnetron sputtering method”. Either of these methods can be used, but the “RF sputtering method” is more preferable because it can efficiently form a desired alloy of the invention.

For example, in a case where the alloy layer is formed by the RF sputtering method using a sputtering target made of a FePt alloy (atomic composition ratio Fe/Pt=50/50), the following conditions can preferably be used: that is, support temperature at about 450° C., sputtering gas pressure at about 50 Pa, and distance between target and substrate at about 95 mm. Here, the conditions are shown as merely examples and it is preferable to set the conditions appropriately depending on the FePt composition and the magnetic recording medium to be applied. In this regard, in the case that this method is used, it is preferable, when selecting an organic support, to take into consideration of its heat resistance.

After the layer is formed on the support by the sputtering method, the above-mentioned oxidizing treatment (exposing the layer to the air or the like) and the annealing treatment can be performed. Here, in this specification, a laminated material on which a layer containing the alloy is formed on the support by the sputtering method, as described above, is for the sake of convenience also called a magnetic particle-coated material.

The alloy particles are transformed from the disordered phase to the ordered phase by the annealing treatment described above to produce magnetic particles having ferromagnetism, and a magnetic particle-coated material can be manufactured in which a coating film containing at least magnetic particles is formed on the organic support.

Although the manufactured magnetic particle-coated material uses the organic support, it is not degraded and deformed and has characteristics of being both inexpensive and resistant to cracking as compared to inorganic supports such as Si and glass.

In the magnetic particles manufactured by the above-mentioned method of manufacturing a magnetic particle-coated material of the invention, their magnetic coercive force preferably ranges from 95.5 kA/m to 398 kA/m (from 1,200 Oe to 5,000 Oe), and taking into consideration of the need for the recording head to be able to adapt to a case where it is applied to a magnetic recording medium, more preferably from 95.5 kA/m to 278.6 kA/m (from 1,200 Oe to 3,500 Oe).

Moreover, the size of the magnetic particle preferably ranges from 1 nm to 100 nm, and more preferably from 3 nm to 20 nm, and still more preferably from 3 nm to 10 nm.

Magnetic Recording Medium

The magnetic recording medium of the invention is of the type in which the above-mentioned magnetic particle-coated material can be applied to magnetic recording medium. That is, the magnetic recording medium of the invention has at least an organic support and a magnetic layer having a layer containing a CuAu type or Cu₃Au type ferromagnetic ordered alloy phase or with a coating film containing magnetic particles.

Magnetic recording media include magnetic tapes such as videotapes and computer tapes, and magnetic disks such as floppy (R) disks or hard disks.

In a case where the alloy particles (the alloy particle-containing solution) are applied to the support and are subjected to the annealing treatment, thereby becoming magnetic particles, as described above, the layer made of such, magnetic particles can be regarded as the magnetic layer.

The thickness of the magnetic layer formed in this manner preferably ranges from 4 nm to 1 μm, depending on the kind of magnetic recording medium to be applied, and more preferably from 4 nm to 100 nm.

The magnetic recording medium of the invention may have other layers, as required, in addition to the magnetic layer. For example, in the case of a disk it is preferable that another magnetic layer or a non-magnetic layer is further provided on the opposite surface of the magnetic layer. In the case of a tape, it is preferable that a backing layer is provided on the surface of an insoluble support on the opposite side of the magnetic layer.

Moreover, by forming a very thin protective film on the magnetic layer, wear resistance can be improved and by applying a lubricant onto the protective film to improve its ability to slide, a magnetic recording medium of sufficient reliability can be achieved.

Materials for the protective film include oxides such as silica, alumina, titania, zirconia, cobalt oxides, and nickel oxides; nitrides such as titanium nitride, silicon nitride, and boron nitride; carbides such as silicon carbide, chromium carbide, and boron carbide; and carbons such as graphite, amorphous carbon. Hard amorphous carbon generally called diamond-like carbon is especially preferable.

A carbon protective film made of carbon has sufficient wear resistance, even if it is very thin and hence a sliding member is hard to seize up, and thus carbon is suitable as a material for the protective film.

A sputtering method is generally used as a method of forming a carbon protective film in a hard disk, but in a product such as a video tape in which a film needs to be continuously formed, many methods of using a plasma CVD having a higher film forming speed have been proposed. Thus, it is preferable to apply these methods to forming the carbon protective film.

Among these methods, it is reported that a plasma injection CVD (PI-CVD) method has a very high film forming speed and can produce a hard and good-quality carbon protective film having few pin holes (for example, JP-A Nos. 61-130487, 63-279426, and 3-113824).

This carbon protective film preferably has a Vickers hardness of 1000 kg/mm² or more and more preferably 2000 kg/mm² or more. Furthermore, it is preferable that its crystal structure is an amorphous structure and non-conductive.

Then, in a case where a diamond-like carbon film is used as the carbon protective film, it is possible to check its structure by a Raman spectrometric analysis. That is, when the diamond-like carbon film is checked it can be confirmed by a peak detected at from 1520 cm⁻¹ to 1560 cm⁻¹. When the structure of the carbon film is shifted from a diamond-like structure, a peak detected by the Raman spectrometric analysis is shifted from the above range and hardness of the protective film is also reduced.

As a carbon raw material for forming this carbon protective film it is preferable to use carbon-containing compounds including alkanes such as methane, ethane, propane and butane; alkenes such as ethylene and propylene; and alkynes such as acetylene. Moreover, as and when necessary, it is possible to add a carrier gas such as argon and in order to improve the quality of the film an additive gas such as hydrogen or nitrogen.

If the carbon protective film is thick, electromagnetic conversion characteristics deteriorate and adhesion to the magnetic layer decreases, and if the carbon protective film is thin, wear resistance is deficient. Thus, preferably, the film thickness should range from 2.5 nm to 20 nm and more preferably from 5 nm to 10 nm.

Moreover, in order to improve adhesion between this protective film and the magnetic layer which is to become a substrate, it is preferable that the surface of the magnetic layer is reformed, by etching with inert gas or by being exposed to a plasma of a reactive gas such as oxygen.

In order to improve electromagnetic conversion characteristics, the magnetic layer may be formed with a plurality of layers or have a publicly known non-magnetic underlying layer or a middle layer under the magnetic layer. In order to improve running durability and corrosion resistance, as described above, it is preferable to apply to the magnetic layer or to the protective layer a lubricant or rust preventive. A publicly-known hydrocarbon-based lubricant, a fluorine-based lubricant, and an extreme-pressure additive can be used as the lubricant added.

Hydrocarbon-based lubricating agentlubricants include carboxylic acids such as stearic acid and oleic acid; esters such as butyl stearate; sulfonic acids such as octadecylsulfonic acid; phosphate esters such as monoooctadecyl phosphate; alcohols such as stearyl alcohol and oleyl alcohol; carboxylamides such as stearyl amide; and amines such as stearyl amine.

Fluorine-based lubricating agentlubricants include a lubricant in which a portion or all of an alkyl group of the above-mentioned hydrocarbon-based lubricant is substituted by a fluoroalkyl group or by a perfluoropolyether group.

The perfluoropolyether group includes a perfluoromethylene oxide polymer, perfluoroethylene oxide polymer, perfluoro-n-propylene oxide polymer (CF₂CF₂CF₂O)ₙ, perfluoroisopropylene oxide polymer (CF₂(CF₃)CF₂O)ₙ, and copolymers thereof.

Further, compounds having a polar functional group such as a hydroxy group, an ester group and a carboxyl group at the terminal of the alkyl group or in the molecule of the hydrocarbon-based lubricant are suitable because they have a considerable effect in reducing the frictional force.

Still further, their molecular weight ranges from 500 to 5,000, and preferably from 1,000 to 3,000. If the molecular weight is smaller than 500, volatility may be high or lubricity may be reduced. Moreover, if the molecular weight is larger than 5,000, viscosity becomes higher and thus a slider tends to adhere to a disk, a fact which can cause a stoppage or a head crash.

This perfluoropolyether, to be more specific, is commercially available as FOMBLIN® made by Ausimont Inc. and KRYTOX® made by Dupont Corp.

The extreme-pressure additive includes phosphate esters such as trilauryl phosphate; phosphite esters such as trilaurylphosphite; thiophosphite esters such as trilauryl trithiophosphite and thiophosphate esters; and sulfur-based extreme-pressure additives such as benzyl disulfide.

The above-mentioned lubricants are used alone or in combination. In order to put these lubricants onto the magnetic layer or onto the protective layer, it is recommended that the lubricant is dissolved in an organic solvent and then applied by a wire bar method, a gravure coating method, a spin coating method, or a dip coating method, or is made to adhere thereto by a vacuum vapor deposition method.

The rust preventives include nitrogen-containing heterocycles such as benzotriazole, benzimidazole, purine and pyrimidine and their derivatives in which an alkyl side chain or the like is introduced into its parent nucleus; nitrogen and sulfur containing heterocycles such as benzothiazole, 2-mercaptobenzothiazole, tetrazaindene ring compound and thiouracil compound and their derivatives.

As described above, when the magnetic recording medium is a magnetic tape, a back coat layer (backing layer) may be provided on a surface of the non-magnetic support on which surface the magnetic layer is not formed. The back coat layer is a layer formed by applying to a surface of the non-magnetic support having no magnetic layer formed thereon a coating material forming the back coat layer in which a particulate component such as an abrasive and anti-static agent and a binder are dispersed in a known organic solvent.

Various kinds of inorganic pigments or carbon black can be used as the particulate component. Resins such as nitrocellulose, phenoxy resins, vinyl chloride-based resins, and polyurethanes can be used as the binder, either alone or in combinations thereof.

Moreover, known adhesive layers may be provided on the surface to which the alloy particle-containing solution is applied and on the surface on which the back coat layer is formed.

In the magnetic recording medium manufactured in the manner described above, an average surface roughness at a center line of the surface preferably ranges from 0.1 nm to 5 nm at a cut off value of 0.25 mm, and more preferably from 1 nm to 4 nm. This is because an extremely smooth surface is desirable as a magnetic recording medium for high-density recording.

Among methods of producing such an extremely smooth surface is a method of performing a calendar treatment to the formed magnetic layer. Alternatively, varnishing treatment may be performed on the formed magnetic layer.

The obtained magnetic recording medium can be appropriately punched for use with a punching machine or can be cut into a desired size for use with a cutting machine.

Electromagnetic Shield

An electromagnetic shield of the invention has at least a constituent member of the above-mentioned magnetic particle-coated material.

The magnetic particles contained in the magnetic layer of the magnetic particle-coated material of the invention after annealing treatment are magnetic particles constituting a magnetic material absorbing an electromagnetic waves and each has a structure in which a magnetic particle having a diameter of from about 1 nm to 50 nm is surrounded by a linear polymer (the above-mentioned PVP and the like).

In a case where the magnetic particles having such a structure are used as a magnetic material, in particular, as, an electromagnetic shield material, when the respective magnetic particles are connected to each other like a network, they form a nanogranular structure in which a grain boundary layer having high resistance is formed between the magnetic particles by the linear polymer, and thus they become a magnetic material having a characteristic of absorbing electromagnetic waves.

Moreover, a magnetic material (electromagnetic shield material) absorbing electromagnetic waves is provided, having a structure in which magnetic particles having a diameter of from 1 nm to 50 nm are surrounded by a linear polymer and also having a structure in which powder of the magnetic particles accounts for a volume filling factor of from 30% to 90% with the balance consisting of polymer material.

Thus, the magnetic particle-coated material of the invention can be applied to such an electromagnetic shield material.

In a case where the magnetic particle-coated material of the invention is used as the electromagnetic shield material, the magnetic particle-coated material that is not subjected to the annealing treatment can also preferably be used. This is because the polymer surrounding the nanoparticles is carbonized by the annealing treatment and thereby becomes unable to act as an insulating material. In the case of annealing the magnetic-particle-coated material, it is preferable to use a heat-resistant silicone resin or the like.

The magnetic material having such a construction (electromagnetic shield material) can be formed into an arbitrary shape, for example, a sheet and can be applied to materials of various kinds of components for absorbing electromagnetic waves.

### EXAMPLES

While the present invention will hereinafter be described in more detail on the basis of examples, it is not intended to limit the invention to these examples.

### Example 1

Manufacturing Step of FePt Alloy Particles

The following operation was performed in a high purity N₂ gas.

An alkane solution prepared by mixing 10.8 g of sulfonate type oil-soluble surfactant (trade name: Aerosol OT, manufactured by Wako Pure Chemical Industries, Ltd.), 80 ml of decane (manufactured by Wako Pure Chemical Industries, Ltd.) and 2 ml of oleyl amine (manufactured by Tokyo Kasei Kogyo Co., Ltd.) was added to and mixed with an aqueous reducing agent solution prepared by dissolving 0.76 g of NaBH₄ (manufactured by Wako Pure Chemical Industries, Ltd.) into 16 ml of water (deoxygenated: 0.1 mg/l or less) to prepare a reverse micelle solution (I).

An alkane solution prepared by mixing 5.4 g of sulfonate type oil-soluble surfactant (trade name: Aerosol OT, manufactured by Wako Pure Chemical Industries, Ltd.) and 40 ml of decane was added to and mixed with an aqueous metal salt solution prepared by dissolving 0.46 g of ammonium iron(III) oxalate (Fe(NH₄)₃(C₂O₄)₃) (manufactured by Wako Pure Chemical Industries, Ltd.) and 0.38 g of potassium tetrachloroplatinate(II) (K₂PtCl₄) (manufactured by Wako Pure Chemical Industries, Ltd.) into 12 ml of water (deoxygenated) to prepare a reverse micelle solution (II).

While the reverse micelle solution (I) was being agitated at a high speed at 22° C. by Omnimixer (trade name, manufactured by Yamato Scientific Co., Ltd.), the reverse micelle solution (II) was instantaneously added. After 10 minutes, while the resultant solution was being stirred with a magnetic stirrer, the temperature was increased to 50° C. and aging was conducted for 60 minutes.

Then, 2 ml of oleic acid (manufactured by Wako Pure Chemical Industries, Ltd.) was added to the aged solution and the resultant solution was cooled to room temperature. After cooling, the solution was made open in the atmosphere. In order to destroy the reverse micelle, a mixed solution of 100 ml of water and 100 ml of methanol was added thereto in order to separate the solution into a water phase and an oil phase. The alloy particles were successfully dispersed in the oil phase. The oil phase was washed 5 times with a mixed solution of 600 ml of water and 200 ml of methanol.

Thereafter, 1100 ml of methanol was added thereto to cause the alloy particles to flocculate and to precipitate. The supernatant liquid was removed and 20 ml of heptane (manufactured by Wako Pure Chemical Industries, Ltd.) was added thereto to again disperse the alloy particles.

Moreover, the precipitation caused by the addition of 100 ml of methanol and the dispersion caused by the addition of 20 ml of heptane were repeated twice and finally 5 ml of heptane was added thereto to prepare an alloy particle-containing solution containing FePt alloy particles and having a mass ratio of water to surfactant (water/surfactant) of 2.

The yield, composition, volume average particle diameter and distribution (coefficient of variation) of the obtained alloy particles were measured and the following results were obtained.

Here, the composition and yield were determined by measurement using an ICP spectroscopic analysis (inductively coupled high-frequency plasma emission spectroscopic analysis).

The volume average particle diameter and distribution were determined by measuring particles in the pictures taken with a TEM (transmission electron microscope: manufactured by Hitachi Ltd., 300 kV) and by doing statistical analysis.

The alloy particles to be measured were tailored for use by collecting the alloy particles from the prepared solution containing the alloy particles and sufficiently drying them and heating them in an electric furnace.

Composition: FePt alloy containing 44.5 at % Pt

Yield: 85%

Average particle diameter: 4.2 nm

Coefficient of variation: 5%

Oxidizing Step

The prepared solution containing the alloy particles was vacuum degassed to concentrate so that the alloy particles were contained by 4 mass %. After concentration, the atmosphere was set to an ordinary pressure and then in order to oxidize the alloy particles, an oxygen gas was supplied into the solution containing the alloy particles to conduct oxidizing treatment. The solvent evaporated during the oxidizing treatment was compensated by adding heptane. To the solution after the oxidizing treatment, 0.04 ml of oleyl amine per 1 ml of the solution containing the alloy particles was added.

Coating Step

An organic support of Apical (material: polyimide), manufactured by Kaneka Corp., was coated in the air with a concentrated solution containing alloy particles by the use of a spin coater so that the amount of coated alloy particles became 0.5 g/m², thereby forming a coating film. Before the annealing, treatment, the coated support was subjected to a second oxidizing treatment exposing in the air at 25° C. for 3 hours.

Annealing Step

After the oxidizing step, the coated support was heated at a heating rate of 50° C./min be means of an electric furnace under a H₂ gas atmosphere and was maintained and annealed at temperatures listed in the following Table 1 for 20 minutes and then cooled to room temperature at a cooling rate of 50° C./min to transform the phase of the alloy particles to manufacture a magnetic particle-coated material.

The magnetic characteristics (magnetic coercive force: Hc), condition and crystal structure of the coating film formed on the manufactured magnetic particle-coated material were evaluated. Moreover, the magnetic particles were scraped from the coating film with a spatula and the volume average particle diameter was evaluated. The evaluation results are shown in in the following Table 1.

Moreover, the magnetic characteristics and particle diameter were evaluated by the use of the following apparatus.

Magnetic characteristics: a high-sensitivity vector measurement apparatus and data processing apparatus made by Toei Industry Co., Ltd. (applied magnetic field: 790 kA/m (10 kOe))

Particle diameter: transmission electron microscope made by Hitachi Ltd. (acceleration voltage: 300 kV)

In addition, the condition of the film was evaluated by visually observing the shape of the medium.

### Example 2

A magnetic particle coated material was manufactured in the same way as in example 1 except for using a polyimide material (trade name: Upilex-S, manufactured by Ube Industries, Ltd.) as an organic support and was evaluated in the same way as in the example 1. The evaluation results are shown in the following Table 1.

### Example 3

A magnetic particle coated material was manufactured in the same way as in example 1 except for using as an organic support a support 1A (material: polyetherimide+polyamide) described in the example 1 of JP-A No. 2001-216629 and was evaluated in the same way as in example 1. The evaluation results are shown in the following Table 1.

### Example 4

A magnetic particle coated material was manufactured in the same way as in example 1 except for using a support 1B (material: polyetherimide+polyamide) described in the example 1 of JP-A No. 2001-216629 as anorganic support and was evaluated in the same way as in example 1. The evaluation results are shown in the following Table 1.

### Example 5

A magnetic particle coated material was manufactured in, the same way as in example 2 except for performing annealing treatment for 5 minutes and was evaluated in the same way as in the example 1. The evaluation results are shown in the following Table 1.

### Example 6

A magnetic particle coated material was manufactured in the same way as in example 2 except for performing annealing treatment at 550° C. for 5 minutes and was evaluated in the same way as in example 1. The evaluation results are shown in the following Table 1.

### Example 7

A magnetic particle coated material was manufactured in the same way as in example 2 except for performing annealing treatment in a nitrogen atmosphere at 550° C. for 5 minutes and was evaluated in the same way as in example 1. The evaluation results are shown in the following Table 1.

### Comparative Example 1

A magnetic particle coated material was manufactured in the same way as in example 5 except for using a support made of glass in place of an organic support and was evaluated in the same way as in example 5. The evaluation results are shown in the following Table 1.

TABLE 1

| | | Annealing treatment | | | | Particle | |
|---|---|---|---|---|---|---|---|
| | Kind of | | temperature | time | Hc | diameter | Film |
| | support | atmosphere | (° C.) | (minute) | (kA/m) | (nm) | condition |
| Example 1 | Apical | hydrogen | 400 | 20 | 237 | 5 | no change |
| Example 2 | Upilex | hydrogen | 400 | 20 | 229.1 | 5 | no change |
| Example 3 | support | hydrogen | 400 | 20 | 197.5 | 5 | no change |
| | 1A | | | | | | |
| Example 4 | support | hydrogen | 400 | 20 | 189.6 | 5 | no change |
| | 1B | | | | | | |
| Example 5 | Upilex | hydrogen | 400 | 5 | 120 | 5 | no change |
| Example 6 | Upilex | hydrogen | 550 | 5 | 160 | 5 | no change |
| Example 7 | Upilex | nitrogen | 550 | 5 | 90 | 5 | no change |
| Comparative | glass | hydrogen | 400 | 5 | 115 | 5 | no change |
| Example 1 | | | | | | | |

As is evident from Table 1, since the magnetic particle-coated material was subjected to oxidizing treatment and annealing treatment in a non-oxidizing atmosphere, it was verified that the magnetic particle-coated material in examples 1 to 7 did not have an influence on the coating film, and also had high magnetic coercive force (Hc) even when the organic support was used, as is the case with the support made of glass.

Moreover, the electromagnetic shield characteristics of the magnetic particle-coated material manufactured in example 1 were evaluated in the following manner.

First, a hole of 15 mm×5 mm was made in the electromagnetic shield. The magnetic shield was placed in a communication device emitting a radio wave of 2.4 GHz. Then, the above-mentioned magnetic particle-coated material was put into the hole of the electromagnetic shield and then the level, of an electromagnetic wave radiated from the communication device (shielding level of the electromagnetic shield) was measured.

On the other hand, for the sake of comparison, an evaluation was done in the same manner wherein a glass substrate was employed in place of the above-mentioned magnetic particle-coated material.

In contrast, in the case of the glass substrate, the shield level was −69.9 dB/m. In the case of the above-mentioned magnetic particle-coated material, the shield level was −82.4 dB/m, showing a very good electromagnetic shielding property of 12.5 dB/m.

1. (canceled)

2. (canceled)

3. (canceled)

4. A method of manufacturing a magnetic particle-coated material, the method comprising the sequential steps of:
(i) manufacturing alloy particles capable of forming a CuAu type or Cu₃Au type ferromagnetic ordered alloy phase;
(ii) applying the alloy particles on an organic support to form a coating film; and
(iii) annealing the coating film in a reducing atmosphere to make the alloy particles into magnetic particles, and the method further including the step of:
(iv) oxidizing the alloy particles,
wherein step (iv) is performed at least once, and step (iv) is performed at least once before step (iii).

5. The method of claim 4, wherein step (iv) is performed at least once before step (ii).

6. The method of claim 5, wherein step (iv) is performed at least once between step (ii) and step (iii).

7. A method of manufacturing a magnetic recording medium, the method comprising the sequential steps of:
(i) manufacturing alloy particles capable of forming a CuAu type or Cu₃Au type ferromagnetic ordered alloy phase;
(ii) applying the alloy particles on an organic support to form a coating film; and
(iii) annealing the coating film in a reducing atmosphere to make the alloy particles into magnetic particles wherein the coating film is included in a magnetic layer, and the method further comprising the step of:
(iv) oxidizing the alloy particles, wherein step (iv) is performed before step (iii).

8. The method of claim 7, wherein step (iv) is performed at least once before step (ii).

9. The method of claim 8, wherein step (iv) is performed at least once between step (ii) and step (iii).

10. A method of manufacturing an electromagnetic shield material, the method comprising the sequential steps of:
(i) manufacturing alloy particles capable of forming a CuAu type or Cu₃Au type ferromagnetic ordered alloy phase;
(ii) applying the alloy particles on an organic support to form a coating film; and
(iii) annealing the coating film in a reducing atmosphere to make the alloy particles into magnetic particles,
and the method further comprising the step of:
(iv) oxidizing the alloy particles,
wherein step (iv) is performed before step (iii).

11. The method of claim 10, wherein step (iv) is performed at least once before step (ii).

12. The method of claim 11, wherein step (iv) is performed at least once between step (ii) and step (iii).
